(19) United States
(12) Patent Application Publication
(10) Pub. No.: US 2024/0008076 A1
(43) Pub. Date: Jan. 4, 2024

(54) CHANNEL SENSING FOR SPECTRUM SHARING WITH HIGH PRIORITY SYSTEMS

(71) Applicant: QUALCOMM Incorporated, San Diego, CA (US)

(72) Inventors: Siyi CHEN, Beijing (CN); Arumugam CHENDAMARAI KANNAN, San Diego, CA (US); Changlong XU, Beijing (CN); Jing SUN, San Diego, CA (US); Xiaoxia ZHANG, San Diego, CA (US)

(21) Appl. No.: 18/252,856

(22) PCT Filed: Jan. 12, 2021
(86) PCT No.: PCT/CN2021/071170

§ 371 Date: May 12, 2023

(51) Int. Cl. H04W 74/08

(52) U.S. Cl. CPC H04W 74/0808

(57) ABSTRACT

Various aspects of the present disclosure generally relate to wireless communication. In some aspects, a wireless communication device may sense, using a beam sweeping operation during a channel check period, a shared wireless communication channel. The wireless communication device may perform a wireless communication action based at least in part on whether a high priority wireless communication signal is detected during the beam sweeping operation. Numerous other aspects are described.

### FIELD OF THE DISCLOSURE

Aspects of the present disclosure generally relate to wireless communication and to techniques and apparatuses for channel sensing for spectrum sharing with high priority systems.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a wireless communication device for wireless communication includes a memory; and one or more processors operatively coupled to the memory, the memory and the one or more processors configured to: sense, using a beam sweeping operation during a channel check period, a shared wireless communication channel; and perform a wireless communication action based at least in part on whether a high priority wireless communication signal is detected during the beam sweeping operation.

In some aspects, a method of wireless communication performed by a wireless communication device includes sensing, using a beam sweeping operation during a channel check period, a shared wireless communication channel; and performing a wireless communication action based at least in part on whether a high priority wireless communication signal is detected during the beam sweeping operation.

In some aspects, a non-transitory computer-readable medium storing a set of instructions for wireless communication includes one or more instructions that, when executed by one or more processors of a wireless communication device, cause the wireless communication device to: sense, using a beam sweeping operation during a channel check period, a shared wireless communication channel; and perform a wireless communication action based at least in part on whether a high priority wireless communication signal is detected during the beam sweeping operation.

In some aspects, an apparatus for wireless communication includes means for sensing, using a beam sweeping operation during a channel check period, a shared wireless communication channel; and means for performing a wireless communication action based at least in part on whether a high priority wireless communication signal is detected during the beam sweeping operation.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of wireless communications associated with systems of different priority, in accordance with various aspects of the present disclosure.

FIGS. 4-8 are diagrams illustrating examples associated with channel sensing for spectrum sharing with high priority systems, in accordance with various aspects of the present disclosure.

FIG. 9 is a diagram illustrating an example process associated with channel sensing for spectrum sharing with high priority systems, in accordance with various aspects of the present disclosure.

FIG. 10 is a block diagram of an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

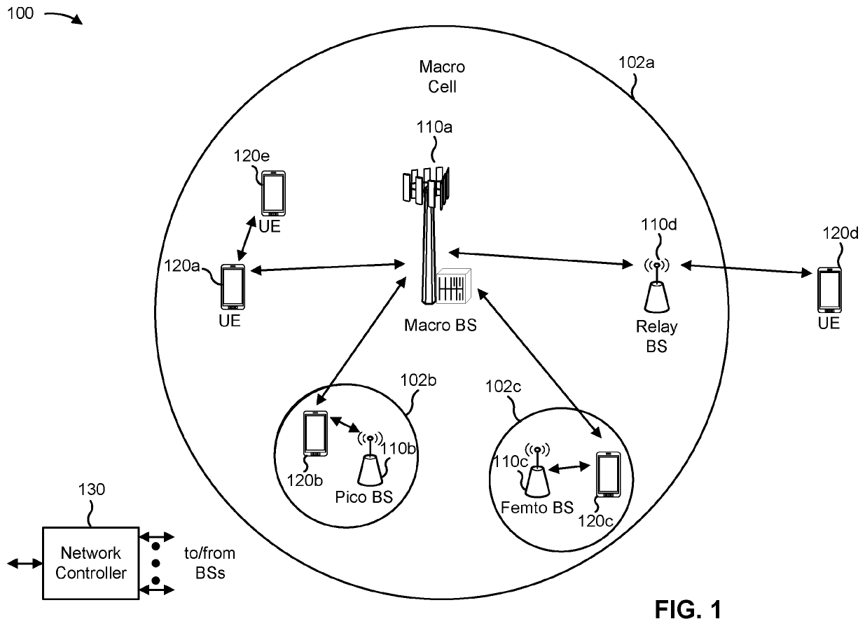

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

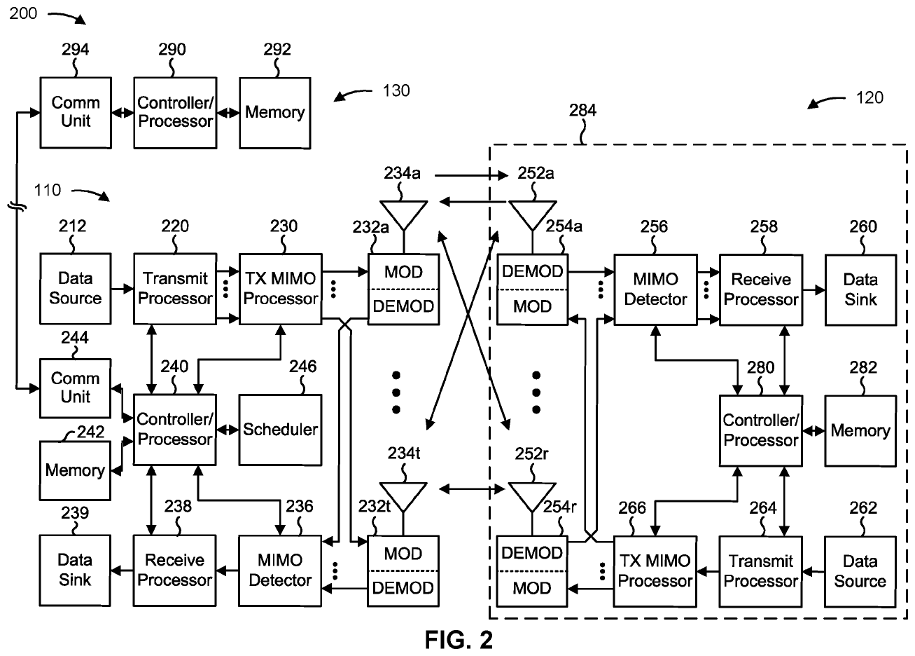

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

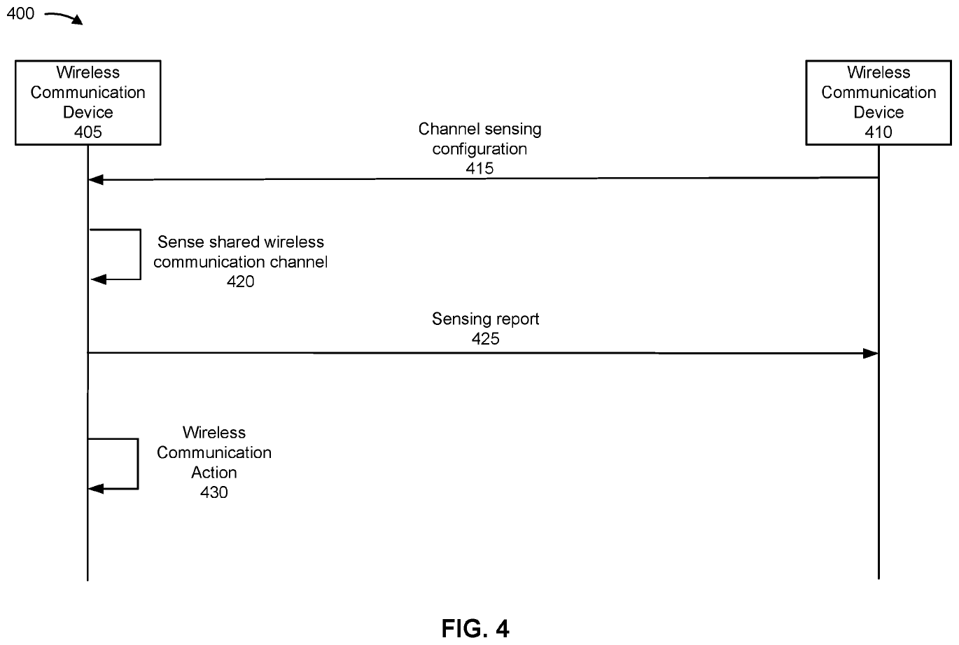

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-9.

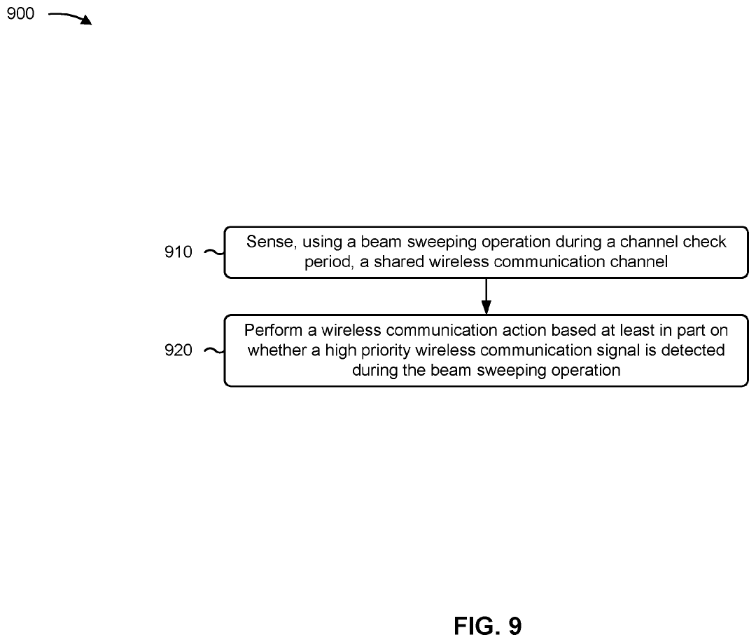

Controller/processor 240 of base station 110, controller/processor 280 of UE 120, and/or any other component(s) of FIG. 2 may perform one or more techniques associated with channel sensing for spectrum sharing with high priority systems, as described in more detail elsewhere herein. In some aspects, the wireless communication device described herein is the base station 110, is included in the base station 110, or includes one or more components of the base station 110 shown in FIG. 2. In some aspects, the wireless communication device described herein is the UE 120, is included in the UE 120, or includes one or more components of the UE 120 shown in FIG. 2. For example, controller/processor 240 of base station 110, controller/processor 280 of UE 120, and/or any other component(s) of FIG. 2 may perform or direct operations of, for example, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, and/or other processes as described herein. In some aspects, executing instructions may include running the instructions, converting the instructions, compiling the instructions, and/or interpreting the instructions, among other examples.

In some aspects, the wireless communication device includes means for sensing, using a beam sweeping operation during a channel check period, a shared wireless communication channel; or means for performing a wireless communication action based at least in part on whether a high priority wireless communication signal is detected during the beam sweeping operation. In some aspects, the means for the wireless communication device to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246. In some aspects, the means for the wireless communication device to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the wireless communication device includes means for determining that a high priority wireless communication signal has not been detected; or means for communicating on the shared wireless communication channel.

In some aspects, the wireless communication device includes means for sensing, using an additional beam sweeping operation, the shared wireless communication channel while performing the wireless communication action. In some aspects, the wireless communication device includes means for detecting a high priority wireless communication signal based at least in part on the additional beam sweeping operation; or means for removing access to the shared wireless communication channel by the wireless communication device based at least in part on detecting the high priority wireless communication signal. In some aspects, the wireless communication device includes means for refraining from transmitting a wireless communication signal during the sensing interval.

In some aspects, the wireless communication device includes means for detecting a high priority wireless communication signal associated with a beam and the shared wireless communication channel; or means for adding the beam and the shared wireless communication channel to a non-occupancy list based at least in part on detecting the high priority wireless communication signal.

In some aspects, the wireless communication device includes means for sensing the shared wireless communication channel for a sensing time that is greater than or equal to a minimum sensing time. In some aspects, the wireless communication device includes means for sensing, during the channel check period, the shared wireless communication channel for a first portion of the sensing time; or means for sensing, during an additional channel check period, the shared communication channel for a second portion of the sensing time, wherein the additional channel check period is separated in time from the channel check period.

In some aspects, the wireless communication device includes means for determining that a high priority wireless communication is not detected; or means for transmitting, to a UE, a channel sensing configuration that indicates an additional beam sweeping operation to be performed by the UE based at least in part on determining that the high priority wireless communication was not detected.

In some aspects, the wireless communication device includes means for receiving, from a base station, a channel sensing configuration that indicates the beam sweeping operation. In some aspects, the wireless communication device includes means for transmitting a sensing report associated with the sensing occasions to the base station, wherein the sensing report indicates a detection status associated with each of a plurality of beams.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

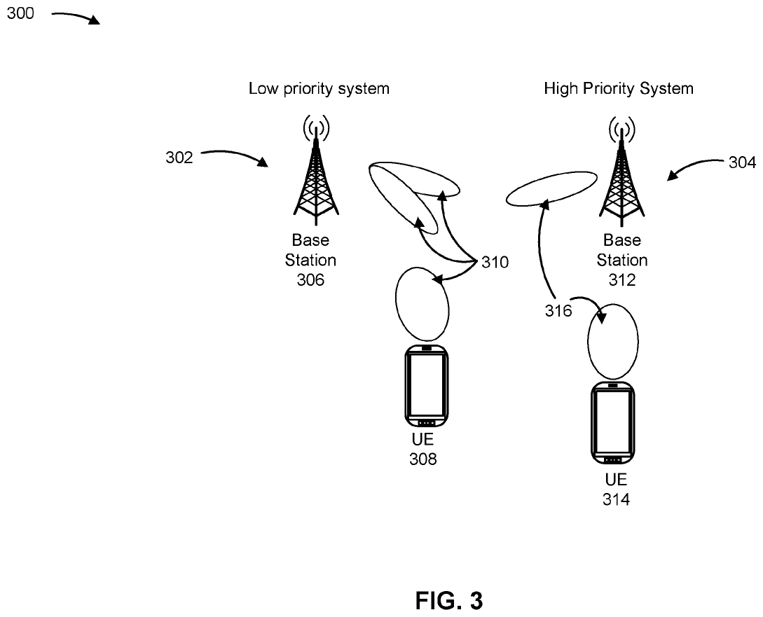

FIG. 3 is a diagram illustrating an example of wireless communications associated with systems of different priority, in accordance with various aspects of the present disclosure. As shown, a low priority system 302 and a high priority system 304 may be implemented proximate one another.

The terms “low priority” and “high priority” may be defined relative to one another and/or in association with one or more conditions. For example, a “low priority” system, device, and/or wireless communication signal may be a respective system, device, and/or wireless communication signal that has an associated priority that is lower than a priority associated with another system, device, and/or wireless communication signal (a “high priority” system, device, and/or wireless communication signal). In some aspects, a “low priority” system, device, and/or wireless communication signal may be a system, device, and/or wireless communication signal that has an associated priority that satisfies a low priority condition. For example, a “low priority” system, device, and/or wireless communication signal may be a system, device, and/or wireless communication signal that has an associated priority that satisfies a low priority threshold and/or other condition. Similarly, for example, a “high priority” system, device, and/or wireless communication signal may be a system, device, and/or wireless communication signal that has an associated priority that satisfies a high priority threshold and/or other condition.

In some aspects, a low priority system, device, and/or wireless communication signal may be a system, device, and/or wireless communication signal that is deemed to be low priority (e.g., in a list, database, lookup table, and/or wireless communication standard, among other examples). Similarly, a high priority system, device, and/or wireless communication signal may be a system, device, and/or wireless communication signal that is deemed to be high priority (e.g., in a list, database, lookup table, and/or wireless communication standard, among other examples). For example, in some aspects, a high priority system may include an emergency communication system, a radar system, and/or a system operated by a government, among other examples. A low priority system may include a newly implemented cellular communication system, an integrated access and backhaul system, and/or an industrial internet of things (IIoT) system, among other examples.

Devices associated with the low priority system 302 may share wireless communication channels with devices associated with the high priority system 304. The wireless communications depicted in FIG. 3 may utilize millimeter wave communications. Sharing of millimeter wave bands (e.g., channels) may be enabled by taking advantage of the highly directive nature of communication links in this high band spectrum. For example, millimeter wave frequencies may allow for use of advanced antenna arrays for beamforming and beam tracking to provide connectivity in both line-of-sight and non-line-of-sight conditions by leveraging path diversity and reflections.

As shown in FIG. 3, the low priority system 302 may include a base station 306 that communicates with a UE 308. A set of beams 310 may be associated with the communication between the base station 306 and the UE 308. As shown in FIG. 3, the high priority system 304 may include a base station 312 that communicates with a UE 314. A set of beams 316 may be associated with the communication between the base station 312 and the UE 314.

In some aspects, the high priority system 304 may be referred to as an incumbent system, and the base station 312 and UE 314 may be referred to as incumbent devices. Incumbent devices and/or incumbent links are devices and/or links, respectively, that have been established prior to introduction of a new wireless communication paradigm. In the case of millimeter wave communication, incumbent links often include fixed point-to-point links between fixed devices. In some implementations, for example, the base station 312 may provide backhaul services for an integrated access and backhaul (IAB) network. In some cases, regulations may require protection of incumbent communication links when carriers introduce new communication paradigms (e.g., when implementing a mobile millimeter wave network).

In some cases, beams 310 associated with the low priority system 302 may collide with beams 316 associated with the high priority system 304. When a new base station is introduced, for example, coexistence of communication links may be enabled based on interference analysis, which may be performed by base stations and/or UEs. For example, in order to enable mobile use cases, the interference analysis may prohibit transmission in a direction of the incumbent receiver. In addition to, or in lieu of, restricting directions of communication, other techniques may be used to facilitate protection of incumbent links. For example, link redundancy and advanced beam management may enable flexibility for beam selection. Database aided protection may be used and/or measurement-aided protection may be used. Many of these protections may result in reduced capabilities of the UE 308 and/or the low priority system 302 serving the UE 308, which may degrade UE performance.

Aspects of techniques and apparatuses described herein may facilitate channel sensing for spectrum sharing with high priority systems such that a low priority device may communicate on a shared channel when the shared channel is not being used by a high priority device. In some aspects, a wireless communication device (e.g., a UE, a base station, and/or an IAB node, among other examples) may sense a shared wireless communication channel. The wireless communication device may use a beam sweeping operation during a channel check period to sense the shared wireless communication channel. The wireless communication device may perform a wireless communication action based at least in part on whether a high priority wireless communication signal is detected during the beam sweeping operation. In some aspects, if a high priority signal is not detected, the wireless communication device may communicate on the shared wireless communication channel. If a high priority signal is detected, the wireless communication device may refrain from communicating on the shared wireless communication channel.

In this way, aspects may facilitate enabling enhanced functionality of a wireless communication device associated with a low priority system by allowing the wireless communication device to communicate using the shared channel when a high priority communication system is not using the shared channel. As a result, aspects may facilitate reduced communication collisions between beams of low priority systems and high priority systems, thereby facilitating improved network performance and/or increased efficiency associated with network resource consumption.

As indicated above, FIG. 3 is provided as an example. Other examples may differ from what is described with regard to FIG. 3.

FIG. 4 is a diagram illustrating an example 400 associated with channel sensing for spectrum sharing with high priority systems, in accordance with various aspects of the present disclosure. As shown, a wireless communication device 405 and a wireless communication device 410 may communicate with one another. The wireless communication device 405 and/or the wireless communication device 410 may include a base station, a UE, an IAB node, a relay node, and/or a CPE, among other examples. In some aspects, the wireless communication device 405 and the wireless communication device 410 may be associated with a low priority system.

As shown by reference number 415, the wireless communication device 410 may transmit, and the wireless communication device 405 may receive, a channel sensing configuration. For example, the wireless communication device 410 may be a base station that transmits the configuration to the wireless communication device 405 (e.g., a UE). In some aspects, the sensing configuration may indicate a beam sweeping operation. In some aspects, the channel sensing configuration may be carried in a system information block (SIB). For example, the wireless communication device 410 may broadcast the sensing configuration in an SIB1.

In some aspects, the sensing configuration may include one or more channel sensing parameters. The one or more channel sensing parameters may include a silencing interval configuration, a minimum channel sensing time, a detection threshold, a channel check period, and/or a channel move time, among other examples. A silencing interval configuration may indicate a time interval during which the wireless communication device 405 and/or other devices communicating in a system with the wireless communication device 405 may sense shared wireless communication channels. In some aspects, devices within the system may be configured to refrain from transmitting signals during the silencing interval. In this way, detection of signals associated with the system may be avoided.

In some aspects, the sensing interval may be associated with a low priority system that includes the wireless communication devices 405 and 410. In some aspects, the sensing interval may be a periodic sensing interval. In some aspects, the sensing interval may include a pseudo periodic sensing interval. For example, the pseudo periodic sensing interval may include a dithered periodic structure with some pseudo randomness on the periodicity that may facilitate avoiding missing periodic transmissions from a high priority system.

In some aspects, the beam sweeping operation may include a contiguous beam sweeping operation. For example, the beam sweeping operation may include a sensing time, Z, associated with a first beam, where the sensing time Z is repeated for a second beam, and so on. The sensing time may be specified in milliseconds, seconds, symbols, and/or slots, among other examples. In some aspects, the beam sweeping operation may include a distributed beam sweeping operation. For example, the sensing time Z may be distributed over a number of beams. In some aspects, for example, a distributed sensing operation may include sensing a shared wireless communication channel during the channel check period for a first portion of the sensing time, sensing during an additional channel check period for a second portion of the sensing time, and so on, where the additional channel check period is separated in time from the channel check period. The sensing occasions may correspond to different beams.

In some aspects, the sensing configuration may indicate a sensing time. A minimum sensing time may include a minimum time for which the wireless communication device 405 should sense the shared wireless communication channel. In some aspects, the minimum sensing time may be contiguous and/or distributed. For example, the minimum sensing time may include a first portion corresponding to a first beam, a second portion corresponding to a second beam, and so on. In some aspects, the minimum sensing time may correspond to each of a plurality of beams.

In some aspects, a detection threshold may indicate a threshold associated with detecting a high priority wireless communication signal. A high priority wireless communication signal may include a wireless communication signal that has an associated priority that is a high priority, as the term is used herein. In some aspects, a high priority wireless communication signal may include any signal that is transmitted by or to a device associated with a high priority system. In some aspects, the detection threshold may be specified in terms of energy, spectral density, amplitude, frequency, RSRP, RSRQ, and/or any number of other radiofrequency parameters.

In some aspects, a channel check period may refer to a time period during which a sensing operation is performed. The channel check period may be a time period within a sensing interval and may be less than or equal to the sensing interval. In some aspects, a channel move time may refer to a time period and/or a duration of time during which devices associated with the low priority system cease all transmissions on the sensed channel based at least in part on detection of a high priority wireless communication signal associated with the channel.

As shown by reference number 420, the wireless communication device 405 may sense, using a beam sweeping operation during a channel check period, a shared wireless communication channel. In some aspects, the wireless communication device 405 may sense the shared wireless communication channel in accordance with the sensing configuration. As shown by reference number 425, the wireless communication device 405 may transmit, and the wireless communication device 410 may receive, a sensing report associated with the sensing operation. In some aspects, the sensing report may indicate a detection status associated with each of a plurality of beams. The detection status may indicate whether a high priority wireless communication signal was detected in association with the respective beam.

As shown by reference number 430, the wireless communication device 405 may perform a wireless communication action based at least in part on whether a high priority wireless communication signal is detected during the beam sweeping operation. For example, in some aspects, the wireless communication device 405 may determine that a high priority wireless communication signal has not been detected and may communicate on the shared wireless communication channel based at least in part on this determination.

In some aspects, the wireless communication device 405 may continue sensing on the channel while communicating on the channel (e.g., during communications or between communications). For example, the wireless communication device may sense, using an additional beam sweeping operation, the shared wireless communication channel while performing the wireless communication action. In some aspects, the wireless communication device 405 may detect a high priority wireless communication signal based at least in part on the additional beam sweeping operation and may remove access to the shared wireless communication channel by the wireless communication device based at least in part on detecting the high priority wireless communication signal.

In some aspects, the wireless communication device 405 may detect a high priority wireless communication signal associated with a beam and the shared wireless communication channel. In some aspects, the wireless communication device 405 may add the beam and the shared wireless communication channel to a non-occupancy list based at least in part on detecting the high priority wireless communication signal. The non-occupancy list may indicate one or more channels that are not to be used by the wireless communication device 405. In some aspects, a beam and/or channel may remain on the non-occupancy list for a specified duration and/or until a high priority wireless communication is not detected on the beam and/or channel for a specified amount of time.

In some aspects, the wireless communication device 405 may perform the wireless communication action based at least in part on transmitting a physical random access channel (PRACH) signal on the beam that is sensed. In this manner, for example, the wireless communication device 405 may indicate to the wireless communication device 410 that the wireless communication device 405 can access the channel using the beam. As a result, the wireless communication device 405 may use the PRACH signal to indicate an available beam direction for a following communication.

Some aspects of the subject matter disclosed herein may support UE-assisted sensing. For example, in some aspects, the wireless communication device 405 may be a base station (in which case, the operation associated with reference number 415 may not be performed). The wireless communication device 405 may determine that a high priority wireless communication is not detected, and may transmit, to the wireless communication device 410 (e.g., a UE), a channel sensing configuration that indicates an additional beam sweeping operation to be performed by the wireless communication device 410 based at least in part on determining that the high priority wireless communication was not detected.

As indicated above, FIG. 4 is provided as an example. Other examples may differ from what is described with regard to FIG. 4.

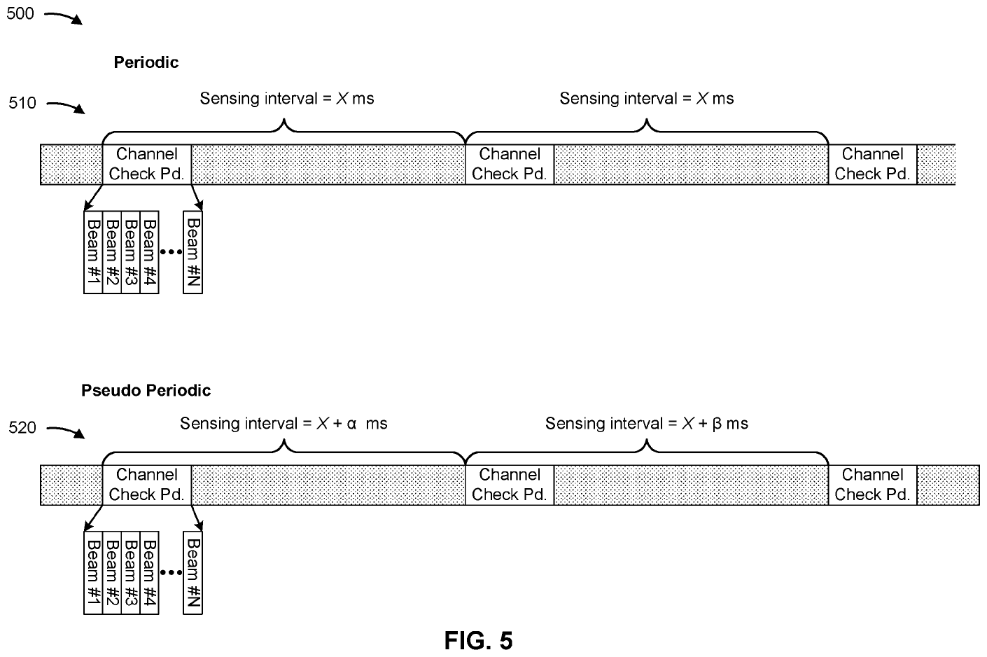

FIG. 5 is a diagram illustrating an example 500 associated with channel sensing for spectrum sharing with high priority systems, in accordance with various aspects of the present disclosure. Example 500 illustrates a comparison between an example 510 of a periodic sensing interval and an example 520 of a pseudo periodic sensing interval.

As shown by reference number 510, a periodic sensing interval may be configured to be a consistent X milliseconds (ms) long, where a channel check period (shown as “channel check pd.”) occurs within the X ms. During the channel check period, a wireless communication device may be configured to sense, on each of a plurality of beams (labeled as “Beam #1,” “Beam #2,” . . . “Beam #N”), a shared wireless communication channel as described herein.

As shown by reference number 520, a pseudo periodic sensing interval may include a dithered periodic structure with some pseudo randomness on the periodicity to avoid missing periodic transmissions from a high priority system. For example, a random or pseudo random constant (two values of which are shown as “α” and “β”) may be added to the periodic sensing interval duration X to determine a sensing interval for each sensing occasion. The channel check period occurs within each sensing interval. This pseudo randomness may distribute the sensing occasions in a pseudo random manner, which may increase the chance that a high priority wireless communication will be detected by the wireless communication device.

As indicated above, FIG. 5 is provided as an example. Other examples may differ from what is described with regard to FIG. 5.

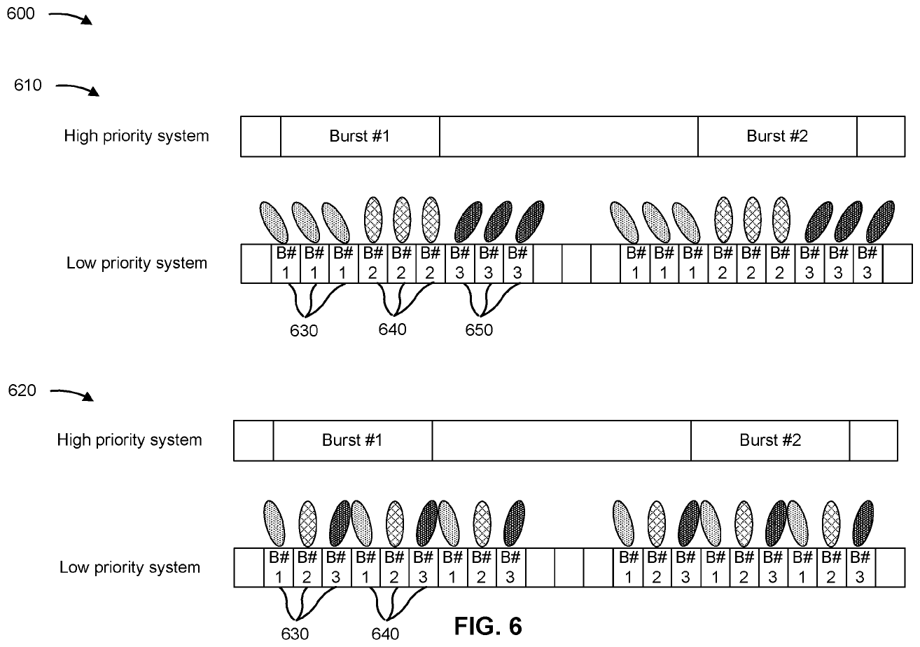

FIG. 6 is a diagram illustrating an example 600 associated with channel sensing for spectrum sharing with high priority systems, in accordance with various aspects of the present disclosure. Example 600 illustrates a comparison between an example 610 of a contiguous beam sweeping operation in which beam sensing occasions are contiguous and an example 620 of a distributed beam sweeping operation in which beam sensing occasions are contiguous.

As shown by reference number 610, a wireless communication device may perform a contiguous beam sweeping operation by sensing, during each of a first set 630 of portions of a sensing interval, on a first beam (shown as “B #1”); sensing, during each of a second set 640 of portions of the sensing interval, on a second beam (shown as “B #2”); and sensing, during each of a third set 650 of portions of the sensing interval, on a third beam (shown as “B #3”). As shown by reference number 610, this contiguous beam sweeping may cause a first high priority wireless signal (shown as “burst #1”) to be missed by the third beam and a second high priority wireless signal (shown as “burst #2”) to be missed by the first beam.

As shown by reference number 620, the wireless communication device may perform a distributed beam sweeping operation by sensing, during a first portion of the first set 630 of portions of a sensing interval, on the first beam; sensing, during a second portion of the first set 630 of portions of the sensing interval, on the second beam; and sensing, during a third portion of the first set 630 of portions of the sensing interval, on the third beam. The same procedure may be repeated, for example, with respect to the second set 640 of portions of the sensing interval, and so on. As shown by reference number 620, this distributed beam sweeping may result in both high priority wireless signals being detected by each of the beams.

As indicated above, FIG. 6 is provided as an example. Other examples may differ from what is described with regard to FIG. 6.

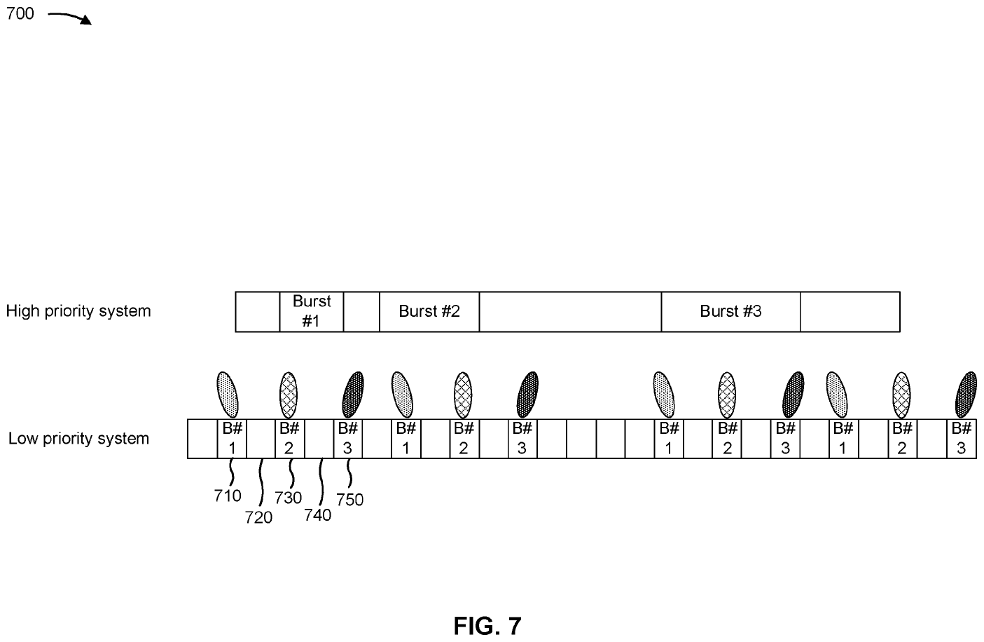

FIG. 7 is a diagram illustrating an example 700 associated with channel sensing for spectrum sharing with high priority systems, in accordance with various aspects of the present disclosure. Example 700 illustrates a distributed beam sweeping operation in which beam sensing occasions are distributed.

As shown, a wireless communication device may perform a distributed beam sweeping operation by sensing, during a first portion 710 of a sensing interval, on a first beam (shown as “B #1”); refraining from sensing during a second portion 720 of the sensing interval; sensing, during a third portion 730 of the sensing interval, on a second beam (shown as “B #2”); refraining from sensing during a fourth portion 740 of the sensing interval; sensing, during a fifth portion 750 of the sensing interval, on a third beam (shown as “B #3”); and repeating this pattern. The same procedure may be repeated, for example, with respect to each sensing interval. As shown, this distributed beam sweeping with distributed sensing occasions may result in high priority wireless signals of different lengths being detected by one or more of the beams.

As indicated above, FIG. 7 is provided as an example. Other examples may differ from what is described with regard to FIG. 7.

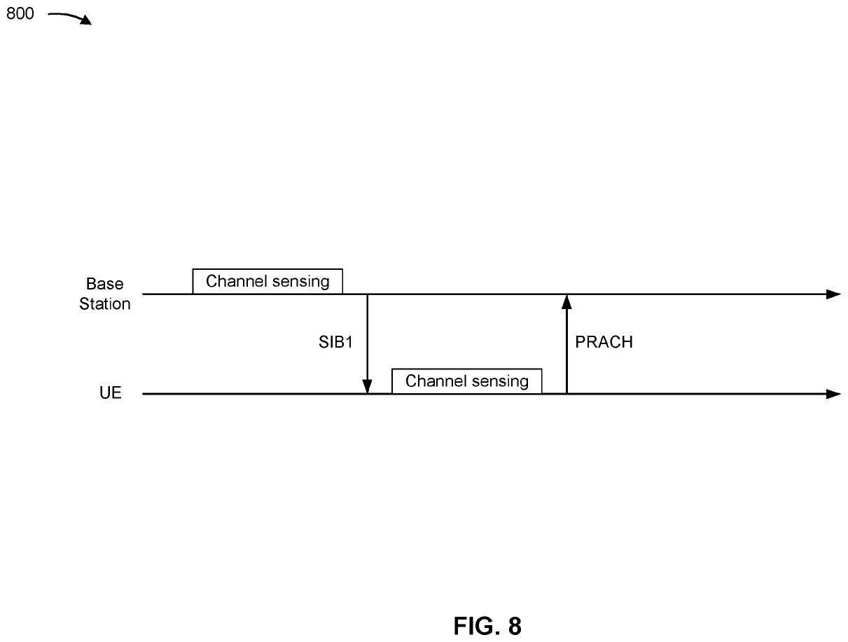

FIG. 8 is a diagram illustrating an example 800 associated with channel sensing for spectrum sharing with high priority systems, in accordance with various aspects of the present disclosure. Example 800 illustrates an example of a procedure for UE-assisted sensing. For example, in some aspects, due to the nature of beamforming, a base station may not be able to detect all aspects of interference with high priority wireless communication systems, devices, and/or signals. To account for this, aspects may include sensing by both the base station and a UE.

For example, as shown, a base station may perform channel sensing and may determine that a high priority wireless communication is not detected. Based at least in part on that determination, the base station may transmit, to the UE, an SIB1 transmission that includes a channel sensing configuration. The channel sensing configuration may indicate an additional beam sweeping operation to be performed by the UE. The UE may perform channel sensing and, upon determining that a high priority wireless communication signal is not detected, may transmit a PRACH signal to the base station.

The PRACH signal may initiate access to the channel and, by transmitting the PRACH signal on the beam that was sensed, may implicitly indicate, to the base station, a transmission direction (beam) to be used by the base station for a subsequent transmission to the UE. In some aspects, the UE may periodically refresh its status by receiving a sensing configuration from the base station and providing a sensing report to the base station that includes per-beam sensing status indications.

As indicated above, FIG. 8 is provided as an example. Other examples may differ from what is described with regard to FIG. 8.

FIG. 9 is a diagram illustrating an example process 900 performed, for example, by a wireless communication device, in accordance with various aspects of the present disclosure. Example process 900 is an example where the wireless communication device (e.g., wireless communication device 405) performs operations associated with channel sensing for spectrum sharing with high priority systems.

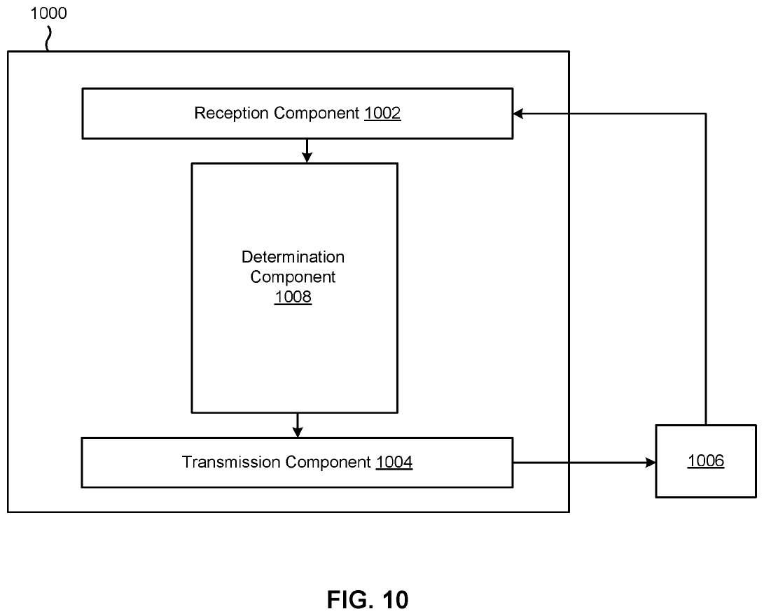

As shown in FIG. 9, in some aspects, process 900 may include sensing, using a beam sweeping operation during a channel check period, a shared wireless communication channel (block 910). For example, the wireless communication device (e.g., using reception component 1002, transmission component 1004, and/or determination component 1008, depicted in FIG. 10) may sense, using a beam sweeping operation during a channel check period, a shared wireless communication channel, as described above.

As further shown in FIG. 9, in some aspects, process 900 may include performing a wireless communication action based at least in part on whether a high priority wireless communication signal is detected during the beam sweeping operation (block 920). For example, the wireless communication device (e.g., using reception component 1002, transmission component 1004, and/or determination component 1008, depicted in FIG. 10) may perform a wireless communication action based at least in part on whether a high priority wireless communication signal is detected during the beam sweeping operation, as described above.

Process 900 may include additional aspects, such as any single aspect or any combination of aspects described below and/or in connection with one or more other processes described elsewhere herein.

In a first aspect, process 900 includes determining that a high priority wireless communication signal has not been detected, and wherein performing the wireless communication action comprises communicating on the shared wireless communication channel.

In a second aspect, alone or in combination with the first aspect, process 900 includes sensing, using an additional beam sweeping operation, the shared wireless communication channel while performing the wireless communication action.

In a third aspect, alone or in combination with the second aspect, process 900 includes detecting a high priority wireless communication signal based at least in part on the additional beam sweeping operation, and removing access to the shared wireless communication channel by the wireless communication device based at least in part on detecting the high priority wireless communication signal.

In a fourth aspect, alone or in combination with one or more of the first through third aspects, the channel check period corresponds to a sensing interval associated with a low priority system that includes the wireless communication device.

In a fifth aspect, alone or in combination with the fourth aspect, process 900 includes refraining from transmitting a wireless communication signal during the sensing interval.

In a sixth aspect, alone or in combination with one or more of the fourth through fifth aspects, the sensing interval comprises a periodic sensing interval.

In a seventh aspect, alone or in combination with one or more of the first through sixth aspects, the sensing interval comprises a pseudo periodic sensing interval.

In an eighth aspect, alone or in combination with one or more of the first through seventh aspects, process 900 includes detecting a high priority wireless communication signal associated with a beam and the shared wireless communication channel, and adding the beam and the shared wireless communication channel to a non-occupancy list based at least in part on detecting the high priority wireless communication signal.

In a ninth aspect, alone or in combination with one or more of the first through eighth aspects, the beam sweeping operation comprises a contiguous beam sweeping operation.

In a tenth aspect, alone or in combination with one or more of the first through eighth aspects, the beam sweeping operation comprises a distributed beam sweeping operation.

In an eleventh aspect, alone or in combination with one or more of the first through tenth aspects, process 900 includes sensing the shared wireless communication channel for a sensing time that is greater than or equal to a minimum sensing time.

In a twelfth aspect, alone or in combination with the eleventh aspect, the minimum sensing time is distributed over time, and wherein sensing the shared wireless communication channel for the sensing time comprises sensing, during the channel check period, the shared wireless communication channel for a first portion of the sensing time, and sensing, during an additional channel check period, the shared communication channel for a second portion of the sensing time, wherein the additional channel check period is separated in time from the channel check period.

In a thirteenth aspect, alone or in combination with one or more of the first through seventh or ninth through twelfth aspects, process 900 includes determining that a high priority wireless communication is not detected, and transmitting, to a UE, a channel sensing configuration that indicates an additional beam sweeping operation to be performed by the UE based at least in part on determining that the high priority wireless communication was not detected.

In a fourteenth aspect, alone or in combination with one or more of the first through thirteenth aspects, the wireless communication device comprises a base station.

In a fifteenth aspect, alone or in combination with one or more of the first through thirteenth aspects, process 900 includes receiving, from a base station, a channel sensing configuration that indicates the beam sweeping operation.

In a sixteenth aspect, alone or in combination with the fifteenth aspect, the channel sensing configuration comprises one or more channel sensing parameters.

In a seventeenth aspect, alone or in combination with the sixteenth aspect, the one or more channel sensing parameters comprises at least one of a silencing interval configuration, or a minimum channel sensing time.

In an eighteenth aspect, alone or in combination with one or more of the fifteenth through seventeenth aspects, the channel sensing configuration is carried in a system information block.

In a nineteenth aspect, alone or in combination with one or more of the fifteenth through eighteenth aspects, the channel sensing configuration indicates one or more sensing occasions, the method further comprising transmitting a sensing report associated with the sensing occasions to the base station, wherein the sensing report indicates a detection status associated with each of a plurality of beams.

In a twentieth aspect, alone or in combination with one or more of the first through thirteenth or fifteenth through nineteenth aspects, sensing, using the beam sweeping operation, comprises sensing on a beam, and wherein performing the wireless communication action comprises transmitting a physical random access channel signal on the beam.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a wireless communication device, or a wireless communication device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a determination component 1008.

In some aspects, the apparatus 1000 may be configured to perform one or more operations described herein in connection with FIGS. 4-8. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the UE and/or the base station described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE and/or the base station described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding

The reception component 1002, transmission component 1004, and/or determination component 1008 may sense, using a beam sweeping operation during a channel check period, a shared wireless communication channel. The determination component 1008 may perform a wireless communication action based at least in part on whether a high priority wireless communication signal is detected during the beam sweeping operation. In some aspects, the determination component 1008 may include one or more antennas, a modulator, a transmit MIMO processor, a transmit processor, a controller/processor, a memory, or a combination thereof, of the UE and/or base station described above in connection with FIG. 2. The determination component 1008 may include the reception component 1002 and/or the transmission component 1004.

The determination component 1008 may determine that a high priority wireless communication signal has not been detected wherein performing the wireless communication action comprises communicating on the shared wireless communication channel. The reception component 1002, transmission component 1004, and/or determination component 1008 may sense, using an additional beam sweeping operation, the shared wireless communication channel while performing the wireless communication action.

The reception component 1002, transmission component 1004, and/or determination component 1008 may detect a high priority wireless communication signal based at least in part on the additional beam sweeping operation removing access to the shared wireless communication channel by the wireless communication device based at least in part on detecting the high priority wireless communication signal.

The transmission component 1004 may refrain from transmitting a wireless communication signal during the sensing interval.

The reception component 1002, transmission component 1004, and/or determination component 1008 may detect a high priority wireless communication signal associated with a beam and the shared wireless communication channel. The determination component 1008 may add the beam and the shared wireless communication channel to a non-occupancy list based at least in part on detecting the high priority wireless communication signal.

The reception component 1002, transmission component 1004, and/or determination component 1008 may sense the shared wireless communication channel for a sensing time that is greater than or equal to a minimum sensing time.

The determination component 1008 may determine that a high priority wireless communication is not detected. The transmission component 1004 may transmit, to a UE, a channel sensing configuration that indicates an additional beam sweeping operation to be performed by the UE based at least in part on determining that the high priority wireless communication was not detected.

The reception component 1002 may receive, from a base station, a channel sensing configuration that indicates the beam sweeping operation.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some aspects of the present disclosure:

Aspect 1: A method of wireless communication performed by a wireless communication device, comprising: sensing, using a beam sweeping operation during a channel check period, a shared wireless communication channel; and performing a wireless communication action based at least in part on whether a high priority wireless communication signal is detected during the beam sweeping operation.

Aspect 2: The method of aspect 1, further comprising determining that a high priority wireless communication signal has not been detected, and wherein performing the wireless communication action comprises communicating on the shared wireless communication channel.

Aspect 3: The method of aspect 2, further comprising sensing, using an additional beam sweeping operation, the shared wireless communication channel while performing the wireless communication action.

Aspect 4: The method of aspect 3, further comprising detecting a high priority wireless communication signal based at least in part on the additional beam sweeping operation; and removing access to the shared wireless communication channel by the wireless communication device based at least in part on detecting the high priority wireless communication signal.

Aspect 5: The method of any of aspects 1-4, wherein the channel check period corresponds to a sensing interval associated with a low priority system that includes the wireless communication device.

Aspect 6: The method of aspect 5, further comprising refraining from transmitting a wireless communication signal during the sensing interval.

Aspect 7: The method of either of aspects 5 or 6, wherein the sensing interval comprises a periodic sensing interval.

Aspect 8: The method of either of aspects 5 or 6, wherein the sensing interval comprises a pseudo periodic sensing interval.

Aspect 9: The method of any of aspects 1-8, further comprising: detecting a high priority wireless communication signal associated with a beam and the shared wireless communication channel; and adding the beam and the shared wireless communication channel to a non-occupancy list based at least in part on detecting the high priority wireless communication signal.

Aspect 10: The method of any of aspects 1-9, wherein the beam sweeping operation comprises a contiguous beam sweeping operation.

Aspect 11: The method of any of aspects 1-9, wherein the beam sweeping operation comprises a distributed beam sweeping operation.

Aspect 12: The method of any of aspects 1-11, further comprising sensing the shared wireless communication channel for a sensing time that is greater than or equal to a minimum sensing time.

Aspect 13: The method of aspect 12, wherein the minimum sensing time is distributed over time, and wherein sensing the shared wireless communication channel for the sensing time comprises: sensing, during the channel check period, the shared wireless communication channel for a first portion of the sensing time; and sensing, during an additional channel check period, the shared communication channel for a second portion of the sensing time, wherein the additional channel check period is separated in time from the channel check period.

Aspect 14: The method of any of aspects 1-8 or 10-13, further comprising: determining that a high priority wireless communication is not detected; and transmitting, to a user equipment (UE), a channel sensing configuration that indicates an additional beam sweeping operation to be performed by the UE based at least in part on determining that the high priority wireless communication was not detected.

Aspect 15: The method of any of aspects 1-14, wherein the wireless communication device comprises a base station.

Aspect 16: The method of any of aspects 1-14, further comprising receiving, from a base station, a channel sensing configuration that indicates the beam sweeping operation.

Aspect 17: The method of aspect 16, wherein the channel sensing configuration comprises one or more channel sensing parameters.

Aspect 18: The method of aspect 17, wherein the one or more channel sensing parameters comprises at least one of: a silencing interval configuration, or a minimum channel sensing time.

Aspect 19: The method of any of aspects 16-18, wherein the channel sensing configuration is carried in a system information block.

Aspect 20: The method of any of aspects 16-19, wherein the channel sensing configuration indicates one or more sensing occasions, the method further comprising: transmitting a sensing report associated with the sensing occasions to the base station, wherein the sensing report indicates a detection status associated with each of a plurality of beams.

Aspect 21: The method of any of aspects 1-14 or 16-20, wherein sensing, using the beam sweeping operation, comprises sensing on a beam, and wherein performing the wireless communication action comprises transmitting a physical random access channel signal on the beam.

Aspect 22: An apparatus for wireless communication at a device, comprising a processor; memory coupled with the processor; and instructions stored in the memory and executable by the processor to cause the apparatus to perform the method of one or more aspects of aspects 1-21.

Aspect 23: A device for wireless communication, comprising a memory and one or more processors coupled to the memory, the memory and the one or more processors configured to perform the method of one or more aspects of aspects 1-21.

Aspect 24: An apparatus for wireless communication, comprising at least one means for performing the method of one or more aspects of aspects 1-21.

Aspect 25: A non-transitory computer-readable medium storing code for wireless communication, the code comprising instructions executable by a processor to perform the method of one or more aspects of aspects 1-21.

Aspect 26: A non-transitory computer-readable medium storing a set of instructions for wireless communication, the set of instructions comprising one or more instructions that, when executed by one or more processors of a device, cause the device to perform the method of one or more aspects of aspects 1-21.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device for wireless communication, comprising:
a memory; and
one or more processors operatively coupled to the memory, the memory and the one or more processors configured to:
sense, using a beam sweeping operation during a channel check period, a shared wireless communication channel; and
perform a wireless communication action based at least in part on whether a high priority wireless communication signal is detected during the beam sweeping operation.

2. The wireless communication device of claim 1, wherein the one or more processors are further configured to determine that a high priority wireless communication signal has not been detected, and
wherein the one or more processors, when performing the wireless communication action, are configured to communicate on the shared wireless communication channel.

3. The wireless communication device of claim 2, wherein the one or more processors are further configured to sense, using an additional beam sweeping operation, the shared wireless communication channel while performing the wireless communication action.

4. The wireless communication device of claim 3, wherein the one or more processors are further configured to detect a high priority wireless communication signal based at least in part on the additional beam sweeping operation; and
remove access to the shared wireless communication channel by the wireless communication device based at least in part on detecting the high priority wireless communication signal.

5. The wireless communication device of claim 1, wherein the channel check period corresponds to a sensing interval associated with a low priority system that includes the wireless communication device.

6. The wireless communication device of claim 5, wherein the one or more processors are further configured to refrain from transmitting a wireless communication signal during the sensing interval.

7. The wireless communication device of claim 5, wherein the sensing interval comprises a periodic sensing interval.

8. The wireless communication device of claim 5, wherein the sensing interval comprises a pseudo periodic sensing interval.

9. The wireless communication device of claim 1, wherein the one or more processors are further configured to:
detect a high priority wireless communication signal associated with a beam and the shared wireless communication channel; and
add the beam and the shared wireless communication channel to a non-occupancy list based at least in part on detecting the high priority wireless communication signal.

10. The wireless communication device of claim 1, wherein the beam sweeping operation comprises a contiguous beam sweeping operation.

11. The wireless communication device of claim 1, wherein the beam sweeping operation comprises a distributed beam sweeping operation.

12. The wireless communication device of claim 1, wherein the one or more processors are further configured to sense the shared wireless communication channel for a sensing time that is greater than or equal to a minimum sensing time.

13. The wireless communication device of claim 12, wherein the minimum sensing time is distributed over time, and
wherein the one or more processors, when sensing the shared wireless communication channel for the sensing time, are configured to:
sense, during the channel check period, the shared wireless communication channel for a first portion of the sensing time; and
sense, during an additional channel check period, the shared communication channel for a second portion of the sensing time, wherein the additional channel check period is separated in time from the channel check period.

14. The wireless communication device of claim 1, wherein the one or more processors are further configured to:
determine that a high priority wireless communication is not detected; and
transmit, to a user equipment (UE), a channel sensing configuration that indicates an additional beam sweeping operation to be performed by the UE based at least in part on determining that the high priority wireless communication was not detected.

15. The wireless communication device of claim 1, wherein the wireless communication device comprises a base station.

16. The wireless communication device of claim 1, wherein the one or more processors are further configured to receive, from a base station, a channel sensing configuration that indicates the beam sweeping operation.

17. The wireless communication device of claim 16, wherein the channel sensing configuration comprises one or more channel sensing parameters.

18. The wireless communication device of claim 17, wherein the one or more channel sensing parameters comprises at least one of:
a silencing interval configuration, or
a minimum channel sensing time.

19. The wireless communication device of claim 16, wherein the channel sensing configuration is carried in a system information block.

20. The wireless communication device of claim 16, wherein the channel sensing configuration indicates one or more sensing occasions, wherein the one or more processors are further configured to:
transmit a sensing report associated with the sensing occasions to the base station, wherein the sensing report indicates a detection status associated with each of a plurality of beams.

21. The wireless communication device of claim 1, wherein the one or more processors, when sensing, using the beam sweeping operation, are configured to sense on a beam, and
wherein the one or more processors, when performing the wireless communication action, are configured to transmit a physical random access channel signal on the beam.

22. A method of wireless communication performed by a wireless communication device, comprising:
sensing, using a beam sweeping operation during a channel check period, a shared wireless communication channel; and
performing a wireless communication action based at least in part on whether a high priority wireless communication signal is detected during the beam sweeping operation.

23. The method of claim 22, wherein the channel check period corresponds to a sensing interval associated with a low priority system that includes the wireless communication device.

24. The method of claim 22, further comprising:
detecting a high priority wireless communication signal associated with a beam and the shared wireless communication channel; and
adding the beam and the shared wireless communication channel to a non-occupancy list based at least in part on detecting the high priority wireless communication signal.

25. The method of claim 22, further comprising sensing the shared wireless communication channel for a sensing time that is greater than or equal to a minimum sensing time.

26. The method of claim 25, wherein the minimum sensing time is distributed over time, and
wherein sensing the shared wireless communication channel for the sensing time comprises:
sensing, during the channel check period, the shared wireless communication channel for a first portion of the sensing time; and
sensing, during an additional channel check period, the shared communication channel for a second portion of the sensing time, wherein the additional channel check period is separated in time from the channel check period.

27. The method of claim 22, further comprising:
determining that a high priority wireless communication is not detected; and
transmitting, to a user equipment (UE), a channel sensing configuration that indicates an additional beam sweeping operation to be performed by the UE based at least in part on determining that the high priority wireless communication was not detected.

28. The method of claim 22, wherein sensing, using the beam sweeping operation, comprises sensing on a beam, and
wherein performing the wireless communication action comprises transmitting a physical random access channel signal on the beam.

29. A non-transitory computer-readable medium storing a set of instructions for wireless communication, the set of instructions comprising:
one or more instructions that, when executed by one or more processors of a wireless communication device, cause the wireless communication device to:
sense, using a beam sweeping operation during a channel check period, a shared wireless communication channel; and
perform a wireless communication action based at least in part on whether a high priority wireless communication signal is detected during the beam sweeping operation.

30. An apparatus for wireless communication, comprising:
means for sensing, using a beam sweeping operation during a channel check period, a shared wireless communication channel; and
means for performing a wireless communication action based at least in part on whether a high priority wireless communication signal is detected during the beam sweeping operation.
